(19) United States
(12) Patent Application Publication
(10) Pub. No.: US 2014/0306969 A1
(43) Pub. Date: Oct. 16, 2014

(54) Display method and system capable of dynamically adjusting frame rate

(71) Applicant: NOVATEK Microelectronics Corp., Hsin-Chu (TW)

(72) Inventors: Huang-Chin Tang, Hsinchu County (TW); Chun-Yi Chou, Hsinchu City (TW)

(73) Assignee: NOVATEK Microelectronics Corp., Hsin-Chu (TW)

(21) Appl. No.: 13/972,925

(22) Filed: Aug. 22, 2013

(30) Foreign Application Priority Data
Apr. 16, 2013 (TW) 102113530

(51) Int. Cl. G09G 5/00

(52) U.S. Cl. CPC G09G 5/006
USPC 345/520

(57) ABSTRACT

A display method for a monitor is capable of dynamically adjusting a frame rate of a display panel in a monitor. The display method includes storing a display data outputted from a host to a memory unit, generating a control signal according to a frequency of storing the display data to the memory unit, adjusting the frame rate according to the control signal and a predefined adjustment value, and outputting the display data stored in the memory unit to the display panel according to the frame rate.

### BACKGROUND OF THE INVENTION

1. Field of the Invention

The present invention relates to a display method and a display system, and more particularly, to a display method and a display system capable of dynamically adjusting a frame rate of a monitor.

2. Description of the Prior Art

In general, a monitor requires receiving display data outputted from a host by a transmission interface to display on a display panel. In order to correctly transmit the display data, the prior art has provided different transmission interface standards. For example, for requirements of low power and high performance in mobile devices, the prior art provides a Mobile Industry Processor Interface (MIPI) standard. The MIPI standard may be classified into two application modes, which are a video mode and a command mode. In the video mode, the monitor receives the display data and a synchronous signal outputted from the host and synchronously updates internal data with the host to display the display data on the display panel immediately. In the command mode, the host outputs the display data to the monitor only when the display data is updated. In comparison with the video mode, since the host does not output the synchronous signal in the command mode, a driving circuit of the monitor requires generating the synchronous signal itself and displays the display data on the display panel sequentially.

Furthermore, when the driving circuit of the monitor displays the display data on the display panel, if a frame rate of the display data outputted to the display panel is lower than a data updating frequency of the dynamic display data, frame flicker may be perceived by human eyes. Therefore, in the prior art, a frame rate of the monitor is fixed at 60 Hertz (Hz), that is, the display panel of the monitor displays 60 frames within 1 second. However, if the frame rate is higher, the power consumption may be higher. When most applications are utilized for displaying the static display data in the mobile devices (such as displaying pictures or browsing webs, etc.), the display method by utilizing the fixed frame rate has more power consumption. For the mobile devices of the requirements for extremely saving power, the impact is larger.

Thus, for the different transmission interfaces or the different transmission modes of the driving circuit in the monitor, how to provide a display method capable of dynamically adjusting the frame rate is an important topic in the field.

### SUMMARY OF THE INVENTION

It is therefore an objective of the present invention to provide a display method and a display system capable of dynamically adjusting a frame rate of a monitor to reduce power consumption.

The present invention discloses a display method for a monitor capable of dynamically adjusting a frame rate of a display panel in a monitor. The display method comprises storing a display data outputted from a host to a memory unit; generating a control signal according to a frequency of storing the display data to the memory unit; adjusting the frame rate according to the control signal and a predefined adjustment value; and outputting the display data stored in the memory unit to the display panel according to the frame rate.

The present invention further discloses a display system, comprising a host for outputting a display data; a display panel; and a driving circuit, comprising a memory unit, for storing the display data outputted from the host; a detection unit, for generating a control signal according to a frequency of storing the display data to the memory unit; a control unit, for adjusting a frame rate of the display panel according to the control signal and a predefined adjustment value; and an output unit, for outputting the display data stored in the memory unit to the display panel according to the frame rate.

The present invention further discloses a display method for a monitor capable of dynamically adjusting a frame rate of a display panel in the monitor. The display method comprises receiving a display data and a corresponding synchronous signal outputted from a host; temporarily storing the display data in a buffer unit; adjusting the frame rate according to the synchronous signal; and outputting the display data stored in the buffer unit to the display panel according to the frame rate.

The present invention further discloses a display system comprising a host for outputting a display data and a corresponding synchronous signal; a display panel; and a driving circuit, comprising a buffer unit, for temporarily storing the display data; a control unit, for adjusting a frame rate of a display panel according to the synchronous signal; and an output unit, for outputting the display data stored in the buffer unit to the display panel according to the frame rate.

The present invention further discloses a display system comprising a host, for outputting a display data according to a Mobile Industry Processor Interface (MIPI) standard; a display panel; and a driving circuit, for receiving the display data outputted from the host according to the Mobile Industry Processor Interface (MIPI) standard, and dynamically adjusting a frame rate of the display panel; wherein when the host outputs the display data according to a command mode of the Mobile Industry Processor Interface (MIPI) standard, the driving circuit adjusts the frame rate according to a frequency of outputting the display data from the host to the driving circuit, and when the host outputs the display data according to a video mode of the Mobile Industry Processor Interface (MIPI) standard, the driving circuit adjusts the frame rate according to a synchronous signal outputted from the host.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display system according to an embodiment of the present invention.

FIG. 2 is a schematic diagram of an example of internal data of a driving circuit in FIG. 1.

FIG. 3 is a schematic diagram of a display process according to an embodiment of the present invention.

FIG. 4 is a schematic diagram of another display system according to an embodiment of the present invention.

FIG. 5 is a schematic diagram of an example of internal data of a driving circuit in FIG. 4.

FIG. 6 is a schematic diagram of another display process according to an embodiment of the present invention.

FIG. 7 is a schematic diagram of another display system according to an embodiment of the present invention.

FIG. 8 is a schematic diagram of an example of internal data of a driving circuit in FIG. 7.

FIG. 9 is a schematic diagram of another display process according to an embodiment of the present invention.

### DETAILED DESCRIPTION

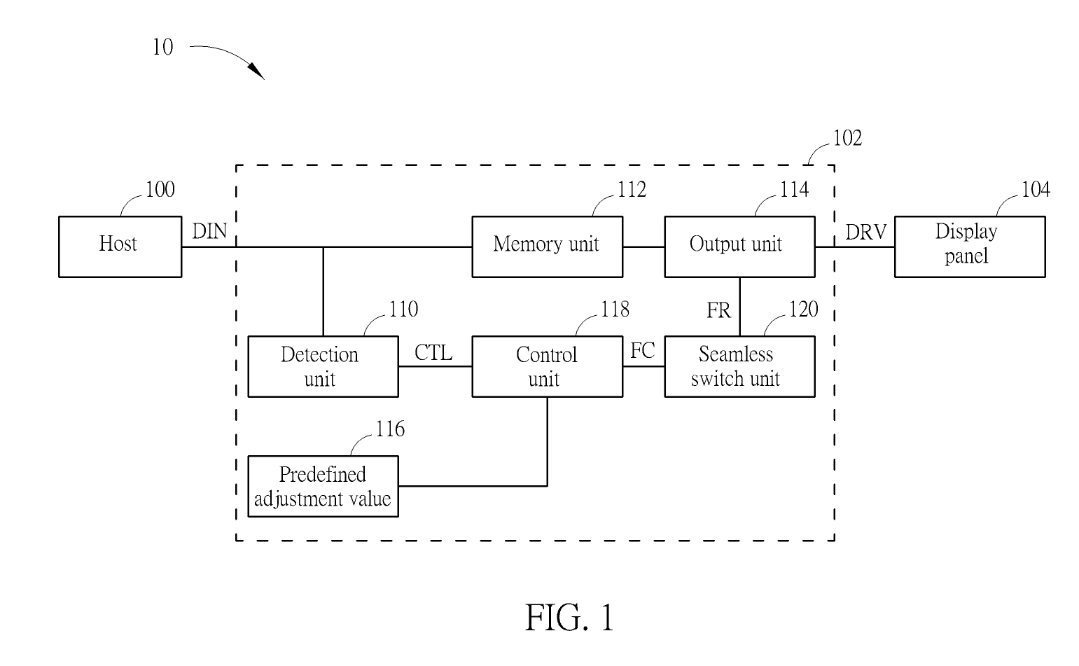

Please refer to FIG. 1, which is a schematic diagram of a display system 10 according to an embodiment of the present invention. As shown in FIG. 1, the display system 10 includes a host 100, a driving circuit 102, and a display panel 104. The host 100 may be a microprocessor of a mobile device or another device providing display data. The host 100 outputs data according to a command mode of a Mobile Industry Processor Interface (MIPI) standard, that is, the host 100 outputs a display data DIN to the driving circuit 102 only when the display data DIN is updated. After the driving circuit 102 receives the display data DIN outputted from the host 100, the driving circuit 102 determines a frame rate of the display panel 104, converts the display data DIN, and outputs a driving signal DRV to the display panel 104 for displaying. The display panel 104 may be an organic light-emitting diode (OLED) panel, or a thin film transistor (TFT) panel, etc, and is not limited herein.

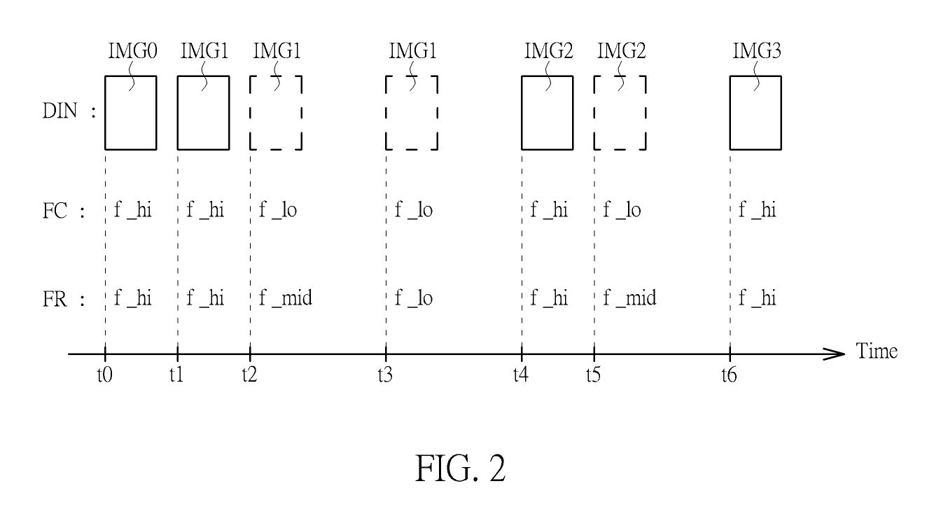

In detail, the driving circuit 102 includes a detection unit 110, a memory unit 112, an output unit 114, a predefined adjustment value 116, a control unit 118, and a seamless switch unit 120. In order to clearly describe an operating method of internal data in the driving circuit 102, please refer to FIG. 2, which is a schematic diagram of an example of the internal data in the driving circuit 102. As shown in FIG. 2, the display data DIN consists of picture data IMG0-IMG3. Since the host 100 outputs the display data DIN to the driving circuit 102 when the display data DIN is updated, the driving circuit 102 stores the picture data IMG0-IMG3 into the memory unit 112 sequentially only at time t0 [symbol] t1 [symbol] t4 [symbol] t6 (i.e. the picture data IMG0-IMG3 described by solid lines in FIG. 2). The memory unit 112 may be a storage media, such as a static random access memory (SRAM), or a dynamic random access memory (DRAM), etc. Additionally, the picture data is not updated at time t2 [symbol] t3 [symbol] t5 (i.e. the picture data IMG1 [symbol] IMG2 described by dotted lines in FIG. 2) to represent that when the static display data is displayed, the host 100 does not output the display data DIN to the driving circuit 102. In such a situation, the driving circuit 102 continually outputs the display data DIN stored in the memory unit 112 to the display panel 104 for displaying.

At the same time, since the detection unit 110 has detected that the picture data IMG0-IMG3 is written to the memory unit 112 at time t0 [symbol] t1 [symbol] t4 [symbol] t6, the detection unit 110 generates a control signal CTL to notify the control unit 118 that the display data is updated. Then, the control unit 118 outputs a target adjustment rate FC as a high frame rate f_hi (such as 60 Hertz) for displaying the dynamic display data with a high data updating frequency. At time t2 [symbol] t3 [symbol] t5, the control unit 118 detects that the display data is not updated by the control signal CTL, and the control unit 118 outputs the target adjustment rate FC as a low frame rate f_lo (such as 50 Hertz) according to the predefined adjustment value 116 to decrease the frame rate for displaying the static display data with a low data updating frequency. Noticeably, the predefined adjustment value 116 is utilized for recording a lowest frame rate of the display pane 104 specified by the display panel manufacture. Since processes and characteristics of display panels are different, holding periods of a display charge-voltage are also different and the lowest frame rates of the display panels are required to be recorded in a storage media, such as a read-only memory (ROM), or a flash ROM, etc. Thereby, the control unit 118 may output the target frame rate FC according to the predefined adjustment value 116 as the lowest frame rate.

Then, the seamless switch unit 120 outputs a frame rate FR based on the target frame rate FC. If the target frame rate FR is adjusted from the high frame rate f_hi to the low frame rate f_lo according to the target frame rate FC, since the frame rate FR is decreased rapidly, frame flicker or response of reduction may be caused and perceived by human eyes. Thus, the seamless switch unit 120 generates and outputs the frame rate FR by utilizing a gradually decreasing method. In detail, when the target frame rate FC is switched from the high frame rate f_hi (such as 60 Hz) to the low frame rate f_lo (such as 50 Hz) at time t2 [symbol] t3, the frame rate FR is first switched to f_mid (such as 55 Hz) and then switched to f_lo (such as 50 Hz). Finally, the output unit 114 outputs the picture data stored in the memory unit 112 according to the frame rate FR, and the output unit 114 generates the driving signal DRV to drive the display panel for displaying.

As a result, the driving circuit 102 obtains the data updating frequency of the display data DIN outputted from the host 100 by detecting whether the display data DIN is stored to the memory unit 112, so as to dynamically adjust the frame rate FR. Thereby, power consumption of the display system 10 may be reduced for saving the power.

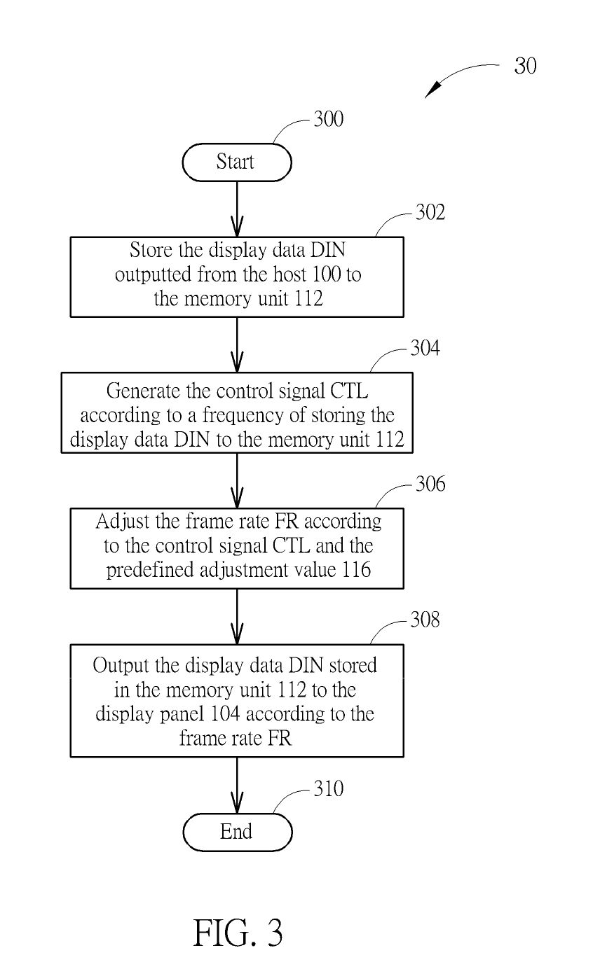

The operating method of the driving circuit 102 may be summarized as a display process 30. As shown in FIG. 3, the display process 30 includes the following steps:

Step 300: start.

Step 302: store the display data DIN outputted from the host 100 to the memory unit 112.

Step 304: generate the control signal CTL according to a frequency of storing the display data DIN to the memory unit 112.

Step 306: adjust the frame rate FR according to the control signal CTL and the predefined adjustment value 116.

Step 308: output the display data DIN stored in the memory unit 112 to the display panel 104 according to the frame rate FR.

Step 310: end.

Detailed description of the display process 30 can be referred from the foregoing description and is not narrated herein for brevity.

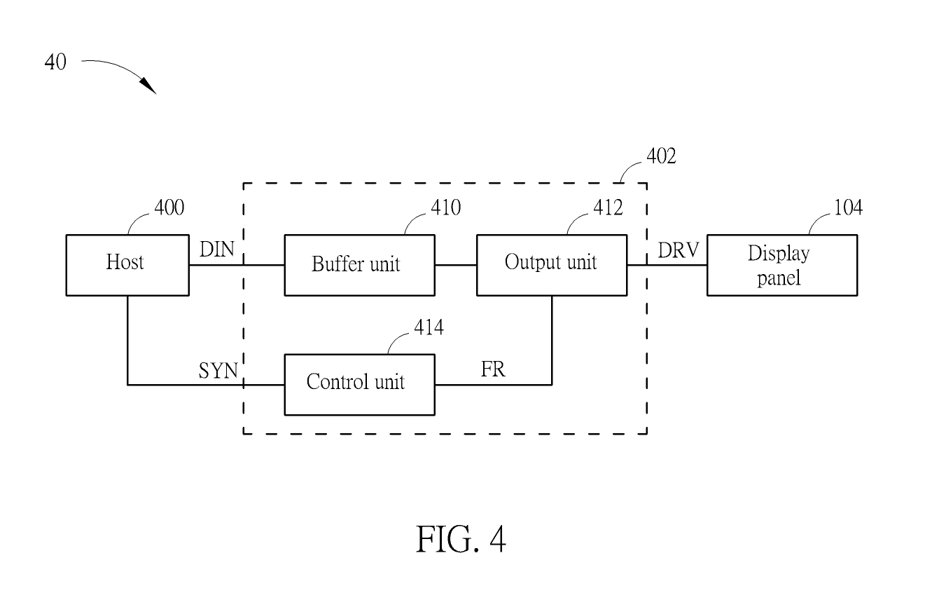

Furthermore, please refer to FIG. 4, which is a schematic diagram of a display system 40 according to an embodiment of the present invention. As shown in FIG. 4, the display system 40 includes a host 400, a driving circuit 402, and the display panel 104. The host 400 outputs data according to a video mode of the MIPI standard, that is, the host 400 outputs the display data DIN and a synchronous signal SYN to the driving circuit 402. The driving circuit 402 receives the display data DIN outputted from the host 400, updates internal data synchronously with the host 400 according to the synchronous signal SYN, and determines the frame rate of the display panel 104. Then, the driving circuit 402 converts the display data DIN and outputs the driving signal DRV to the display panel 104 for displaying.

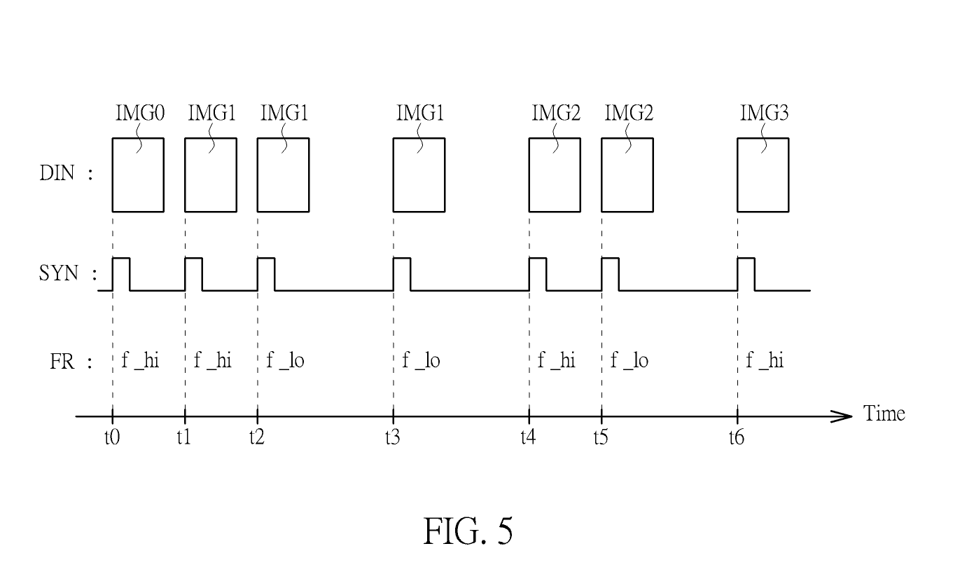

In detail, the driving circuit 402 includes a buffer unit 410, an output unit 412, and a control unit 414. In order to clearly describe an operating method of the internal data in the driving circuit 402, please refer to FIG. 5, which is a schematic diagram of an example of the internal data in the driving circuit 402. As shown in FIG. 5, the display data DIN consists of the picture data IMG0-IMG3. At time t0 [symbol] t1 [symbol] t4 [symbol] t6, the host 500 outputs the picture data IMG0-IMG3 to the driving circuit 402, and the picture data IMG0-IMG3 are temporarily stored in the buffer unit 410, which consists of registers. The host 500 also outputs the synchronous signal SYN with a fixed frequency to the control unit 414. Additionally, although the picture data IMG1-IMG2 is not updated at time t2 [symbol] t3 [symbol] t5, the host 500 similarly outputs the picture data IMG1 [symbol] IMG2 to the driving circuit 402 and the picture data IMG1 [symbol] IMG2 are also stored to the buffer unit 410. At this moment, the host 500 determines that the display data DIN is not updated, and the host 500 decreases the frequency of the synchronous signal SYN to output the synchronous signal SYN with a low frequency.

The control unit 414 may adjust the frame rate FR according to the synchronous signal SYN for synchronously updating the display data DIN with the host 400. At time t0 [symbol] t1 [symbol] t4 [symbol] t6, since the control unit 414 receives the synchronous signal SYN with a fixed frequency, the control unit 414 outputs the frame rate FR as the high frame rate f_hi (such as 60 Hertz). At time t2 [symbol] t3 [symbol] t5, the control unit 414 receives the synchronous signal SYN with a low frequency, and the control unit 414 correspondingly adjusts and decreases the frame rate FR as the low frame rate f_lo (such as 55 Hertz). Finally, the output unit 412 outputs the picture data stored in the buffer unit 410 according to the frame rate FR, and the output unit 114 generates the driving signal DRV to drive the display panel 104 for displaying.

In other words, the host 400 determines the data updating frequency of the display data DIN and adjusts the frequency of the synchronous signal SYN, and the driving circuit 402 dynamically adjusts the frame rate FR according to the synchronous signal SYN outputted from the host 400. Thereby, the power consumption of the display system 40 may be reduced for saving the power.

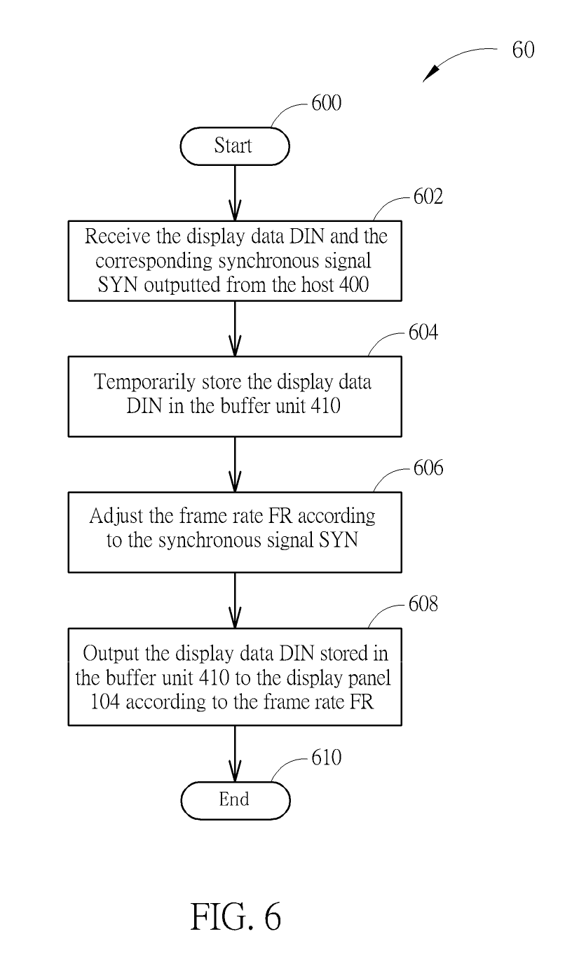

The operating method of the driving circuit 402 may be summarized as a display process 60. As shown in FIG. 6, the display process 60 includes the following steps:

Step 600: start.

Step 602: receive the display data DIN and the corresponding synchronous signal SYN outputted from the host 400.

Step 604: temporarily store the display data DIN in the buffer unit 410.

Step 606: adjust the frame rate FR according to the synchronous signal SYN.

Step 608: output the display data DIN stored in the buffer unit 410 to the display panel 104 according to the frame rate FR.

Step 610: end.

Detailed description of the display process 60 can be referred from the foregoing description and is not narrated herein for brevity.

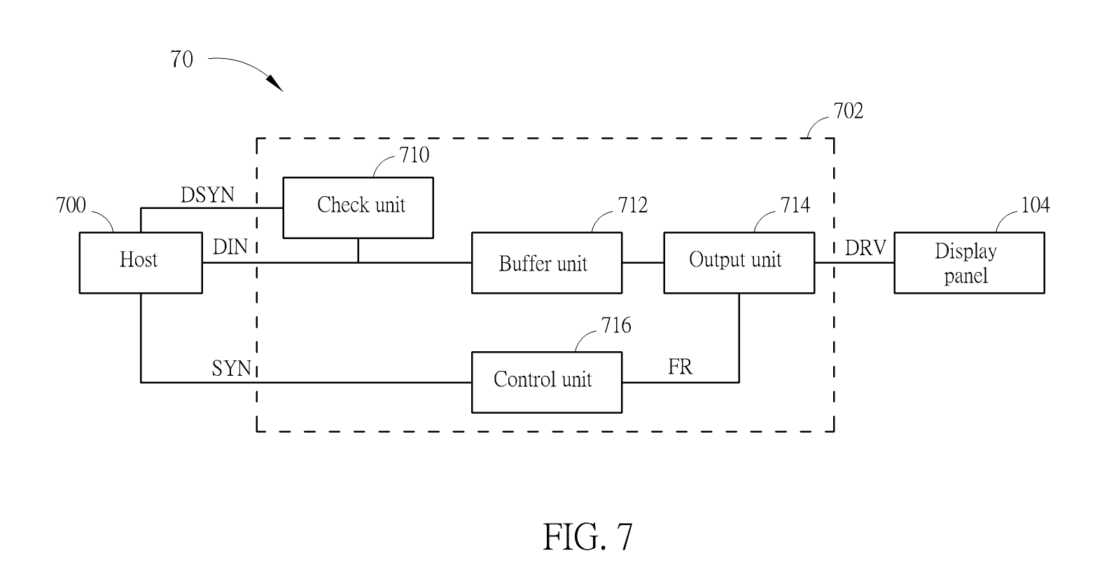

Furthermore, please refer to FIG. 7, which is a schematic diagram of a display system 70 according to an embodiment of the present invention. As shown in FIG. 7, the display system 70 includes a host 700, a driving circuit 702, and the display panel 104. The host 700 outputs data according to the video mode of the MIPI standard, that is, the host 700 outputs the display data DIN and the synchronous signal SYN to the driving circuit 702. The driving circuit 702 receives the display data DIN outputted from the host 400, updates internal data synchronously with the host 400 according to the synchronous signal SYN, and determines the frame rate of the display panel 104. Then, the driving circuit 702 converts the display data DIN and outputs the driving signal DRV to the display panel 104 for displaying. In comparison with the driving circuit 402, the driving circuit 702 further outputs a synchronous control signal DSYN for notifying the host 700 to decrease the output frequency of the synchronous signal SYN.

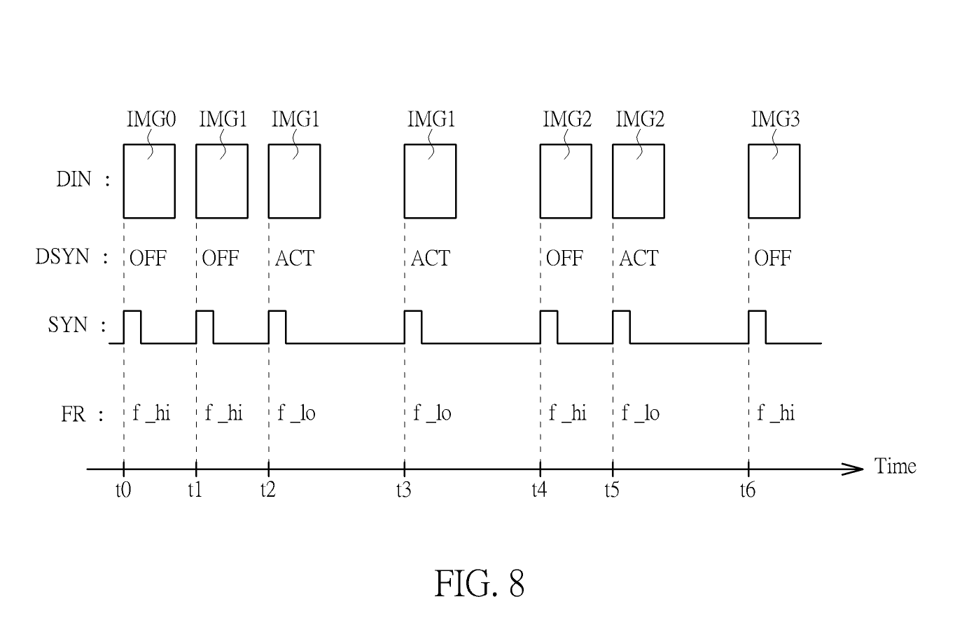

In detail, the driving circuit 702 includes a check unit 710, a buffer unit 712, an output unit 714, and a control unit 716. In order to clearly describe an operating method of the internal data in the driving circuit 702, please refer to FIG. 8, which is a schematic diagram of an example of the internal data in the driving circuit 702. As shown in FIG. 8, the display data DIN consists of picture data IMG0-IMG3. At time t0-t6, the host 700 outputs the picture data IMG0-IMG3 to the driving circuit 402 regardless of whether the picture data IMG0-IMG3 is updated and the picture data IMG0-IMG3 are stored to the buffer unit 712. The host 700 also outputs the synchronous signal SYN to the control unit 716.

The check unit 710 calculates two picture data stored in the buffer unit 712 at different times by a cyclic redundancy check (CRC) algorithm to obtain the difference of the two picture data. For example, at time t1, the picture data IMG0 and IMG1 are calculated to determine that the picture data IMG0 and IMG1 are not the same, and the display data DIN may be regarded as the dynamical display data. Then, the check unit 710 does not transmit the synchronous control signal DSYN to the host 700 (i.e. shown as “OFF” in FIG. 8), and the host 700 may continuously output the synchronous signal SYN with a fixed frequency and the display data DIN. At time t2 [symbol] t3 [symbol] t5, the check unit 710 calculates two picture data stored in the buffer unit 712 at different times to determine that the two picture data are the same. For example, at time t2, the picture data IMG1 and IMG1 are calculated to determine that the picture data IMG1 and IMG1 are the same, and the display data DIN may be regard as the static display data. Then, the check unit 710 transmits the synchronous control signal DSYN to the host 700 (i.e. shown as “ACT” in FIG. 8), and the host 700 may decrease the outputting frequency of the synchronous signal SYN and decrease the outputting rate of the display data DIN.

The control unit 716 adjusts the frame rate FR according to the synchronous signal SYN for synchronously updating the display data DIN with the host 700. At time t0 [symbol] t1 [symbol] t4 [symbol] t6, the control unit 716 outputs the frame rate FR as the high frame rate f_hi (such as 60 Hertz). At time t2 [symbol] t3 [symbol] t5 the control unit 716 outputs the frame rate FR as the low frame rate f_lo (such as 55 Hertz). Finally, the output unit 714 outputs the picture data stored in the buffer unit 712 according to the frame rate FR, and the output unit 714 generates the driving signal DRV to drive the display panel 104 for displaying.

In other words, the driving circuit 702 checks whether the display data DIN outputted from the host 700 is the same to determine the data updating frequency of the display data DIN and notifies the host 700 to decrease the outputting frequency of the synchronous signal SYN. The driving circuit 402 dynamically adjusts the frame rate FR according to the synchronous signal SYN outputted from the host 700. Thereby, the power consumption of the display system 70 may be reduced for saving the power.

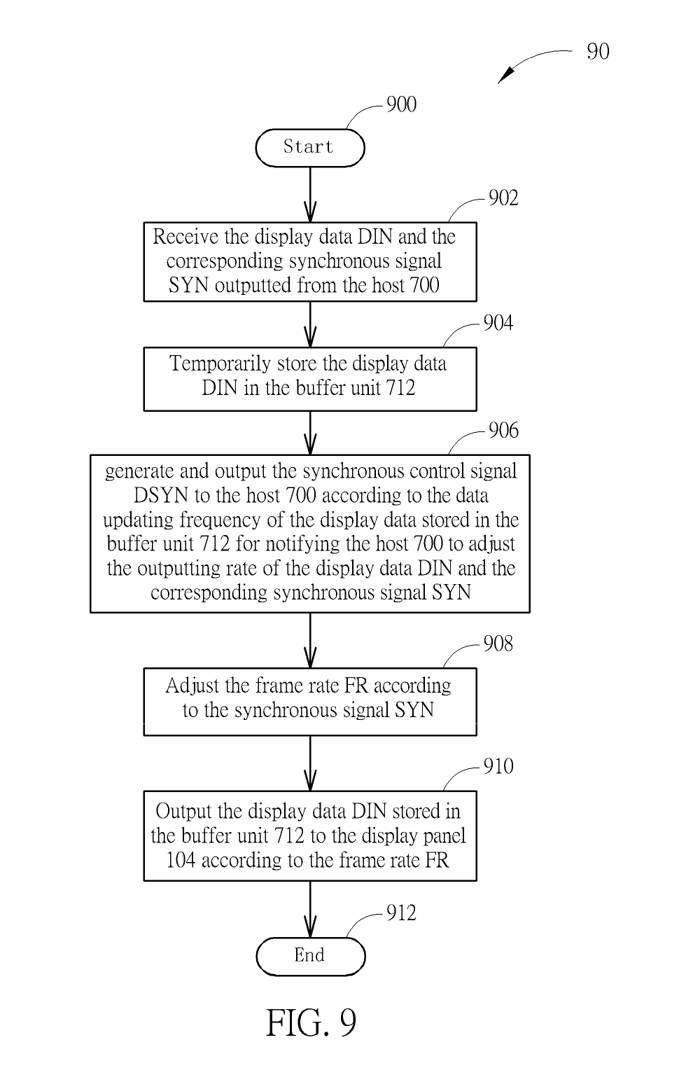

The operating method of the driving circuit 702 may be summarized as a display process 90. As shown in FIG. 9, the display process 90 includes the following steps:

Step 900: start.

Step 902: receive the display data DIN and the corresponding synchronous signal SYN outputted from the host 700.

Step 904: temporarily store the display data DIN in the buffer unit 712.

Step 906: generate and output the synchronous control signal DSYN to the host 700 according to the data updating frequency of the display data stored in the buffer unit 712 for notifying the host 700 to adjust the outputting rate of the display data DIN and the corresponding synchronous signal SYN.

Step 908: adjust the frame rate FR according to the synchronous signal SYN.

Step 910: output the display data DIN stored in the buffer unit 712 to the display panel 104 according to the frame rate FR.

Step 912: end.

Detailed description of the display process 90 can be referred from the foregoing description and is not narrated herein for brevity.

Furthermore, the driving circuits 102 [symbol] 402 [symbol] 702 transmit the data according to the command mode or the video mode of the MIPI standard individually in the embodiments of the present invention. However, the driving circuits 102 [symbol] 402 [symbol] 702 may also be combined as an integrated driving circuit, and the integrated driving circuit may adjust the frame rate according to a transmission mode specified by the host. In other words, when the host transmits the display data according to the command mode of the MIPI standard, the integrated driving circuit adjusts the frame rate according to the data updating frequency of the display data outputted from the host. When the host transmits the display data according to the video mode of the MIPI standard, the integrated driving circuit adjusts the frame rate according to the synchronous signal outputted from the host. Thereby, when the host changes the transmission mode, the integrated circuit may dynamically adjust the frame rate to reduce the power consumption and save the power.

Moreover, the host and the driving circuit in the embodiments of the present invention transmit data according to the MIPI standard, which is not limited. In other embodiments, the host and the driving circuit may also transmit data according to another standard, such as a digital visual interface (DVI) standard, or a high definition multimedia interface (HDMI) standard, etc. Methods of determining the data updating frequency of the display data to dynamically adjust the frame rate of the monitor are all adapted to the present invention, such as the method of the video mode in the MIPI standard, which determines the data updating frequency of the display data by the co-operation of the driving circuit and the host, or the method of the command mode in the MIPI standard, which determines the data updating frequency of the display data only by the driving circuit.

In addition, the example of the display data in the embodiments of the present invention is utilized for explaining that the data updating frequency of the display data outputted from the host may be obtained by determining whether the display data is stored to the memory, or by utilizing the CRC check algorithm to check the display data outputted from the host. The main operation is to obtain the data updating frequency of the display data within a period for determining whether the frame rate may be decreased, which is not limited herein. In other embodiments, the data updating frequency of the display data may also be obtained by determining whether multiple of the display data stored in the memory are the same or different, or the data updating frequency of the display data is obtained to determine whether to decrease the frame rate after the display data is checked for a predefined period

In summary, the prior art utilizes the display method by utilizing the fixed frame rate, and when most applications are utilized for displaying the static display data in the mobile devices, the power consumption is larger. In comparison, the present invention may dynamically adjust the frame rate of the monitor by determining the data updating frequency of the display data to reduce the power consumption.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display method for a monitor capable of dynamically adjusting a frame rate of a display panel in a monitor, the display method comprising:
storing a display data outputted from a host to a memory unit;
generating a control signal according to a frequency of storing the display data to the memory unit;
adjusting the frame rate according to the control signal and a predefined adjustment value; and
outputting the display data stored in the memory unit to the display panel according to the frame rate.

2. The display method of claim 1, wherein the step of adjusting the frame rate according to the control signal and the predefined adjustment value comprises:
gradually decreasing the frame rate according to the control signal and the predefined adjustment value.

3. The display method of claim 1, wherein the predefined adjustment value is corresponding to a lowest frame rate of the display panel in production.

4. The display method of claim 1, wherein the host outputs the display data according to a command mode of a Mobile Industry Processor Interface (MIPI) standard.

5. A display system, comprising:
a host for outputting a display data;
a display panel; and
a driving circuit, comprising:
a memory unit, for storing the display data outputted from the host;
a detection unit, for generating a control signal according to a frequency of storing the display data to the memory unit;
a control unit, for adjusting a frame rate of the display panel according to the control signal and a predefined adjustment value; and
an output unit, for outputting the display data stored in the memory unit to the display panel according to the frame rate.

6. The display system of claim 5, wherein the driving circuit further comprises:
a seamless switch unit, for gradually decreasing the frame rate according to the control signal and the predefined adjustment value.

7. The display system of claim 5, wherein the predefined adjustment value is corresponding to a lowest frame rate of the display panel in production.

8. The display system of claim 5, wherein the host outputs the display data according to a command mode of a Mobile Industry Processor Interface (MIPI) standard.

9. A display method for a monitor capable of dynamically adjusting a frame rate of a display panel in the monitor, the display method comprising:
receiving a display data and a corresponding synchronous signal outputted from a host;
temporarily storing the display data in a buffer unit;
adjusting the frame rate according to the synchronous signal; and
outputting the display data stored in the buffer unit to the display panel according to the frame rate.

10. The display method of claim 9, wherein the host adjusts an outputting rate of the display data and the corresponding synchronous signal according to a data type of the display data.

11. The display method of claim 10, wherein when the data type of the display data is a static picture data, the host decreases the outputting rate.

12. The display method of claim 9 further comprising:
generating and outputting a synchronous control signal to the host according to a data updating frequency of storing the display data in the buffer unit for notifying the host to adjust an outputting rate of the display data and the corresponding synchronous signal.

13. The display method of claim 12 further comprising:
calculating the display data stored in the buffer unit each time by a cyclic redundancy check (CRC) algorithm to determine and obtain the data updating frequency.

14. The display method of claim 9, wherein the host outputs the display data and the synchronous signal according to a video mode of a Mobile Industry Processor Interface (MIPI) standard.

15. A display system comprising:
a host for outputting a display data and a corresponding synchronous signal;
a display panel; and
a driving circuit, comprising:
a buffer unit, for temporarily storing the display data;
a control unit, for adjusting a frame rate of a display panel according to the synchronous signal; and
an output unit, for outputting the display data stored in the buffer unit to the display panel according to the frame rate.

16. The display system of claim 15, wherein the host adjusts an outputting rate of the display data and the corresponding synchronous signal according to a data type of the display data.

17. The display system of claim 16, wherein when the data type of the display data is a static picture data, the host decreases the outputting rate.

18. The display system of claim 15, wherein the driving circuit further comprises:
a check unit, for generating and outputting a synchronous control signal to the host according to a data updating frequency of storing the display data in the buffer unit;
wherein the host adjusts an outputting rate of the display data and the corresponding synchronous signal according to the synchronous control signal.

19. The display system of claim 18, wherein the check unit calculates the display data stored in the buffer unit each time by a cyclic redundancy check (CRC) algorithm to determine and obtain the data updating frequency.

20. The display system of claim 15, wherein the host outputs the display data and the synchronous signal according to a video mode of a Mobile Industry Processor Interface (MIPI) standard.

21. A display system comprising:
a host, for outputting a display data according to a Mobile Industry Processor Interface (MIPI) standard;
a display panel; and
a driving circuit, for receiving the display data outputted from the host according to the Mobile Industry Processor Interface (MIPI) standard, and dynamically adjusting a frame rate of the display panel;
wherein when the host outputs the display data according to a command mode of the Mobile Industry Processor Interface (MIPI) standard, the driving circuit adjusts the frame rate according to a frequency of outputting the display data from the host to the driving circuit, and when the host outputs the display data according to a video mode of the Mobile Industry Processor Interface (MIPI) standard, the driving circuit adjusts the frame rate according to a synchronous signal outputted from the host.
